(19) United States
(12) Patent Application Publication
(10) Pub. No.: US 2020/0065979 A1
(43) Pub. Date: Feb. 27, 2020

(54) IMAGING SYSTEM AND METHOD WITH MOTION DETECTION

(71) Applicant: Himax Imaging Limited, Tainan City (TW)

(72) Inventors: Yuan- Chih Peng, Tainan City (TW); Po-Fang Chen, Tainan City (TW)

(21) Appl. No.: 16/112,022

(22) Filed: Aug. 24, 2018

(51) Int. Cl. G06T 7/246; H04N 5/232

(52) U.S. Cl. CPC G06T 7/248; H04N 5/23245; G06T 2207/20224; G06T 2207/20021; H04N 5/232411

(57) ABSTRACT

An imaging method with motion detection includes determining a windows layout according to a vanishing point or a horizontal line, sizes of windows in the determined windows layout being not uniform; determining features of the windows of a current image; comparing the determined features of the windows of the current image with features of corresponding windows of a previous image to determine whether local motion occurs.

### BACKGROUND OF THE INVENTION

### 1. Field of the Invention

The present invention generally relates to an imaging system and method, and more particularly to an imaging system and method with motion detection.

### 2. Description of Related Art

Cameras have been widely used for image/video based analysis to extract information, for example, due to advance in deep-learning artificial intelligence (AI). A lot of bandwidth and power, however, are required to transmit and process captured image or video. In order to reduce the bandwidth and power, event-triggered cameras have been proposed to screen out redundant image or video such that only images or video containing information being of use are actually transmitted and processed. The information being of use may be identified, for example, whenever motion occurs.

When comparing frames captured at different time to detect motion, features instead of pixels may be compared, thus substantially reducing computing task. Specifically, a frame is equally divided into blocks or windows, features of which are then extracted. Features of a current frame are compared with features of a previous frame to determine whether motion occurs. However, as distant objects are smaller in image size than near objects even they have the same actual size, motion of the distant objects commonly fails to be detected.

For the foregoing reasons, a need has arisen to propose a novel imaging system in order to overcome drawbacks of the conventional imaging systems.

### SUMMARY OF THE INVENTION

In view of the foregoing, it is an object of the embodiment of the present invention to provide an imaging system and method with motion detection capable of preventing detection loss without compromising low power and low cost.

According to one embodiment, an imaging system with motion detection includes an image sensor, a windows layout unit, a feature extractor and a local motion detector. The windows layout unit determines a windows layout according to a vanishing point or a horizontal line, sizes of windows in the determined windows layout being not uniform. The feature extractor determines features of the windows of a current image. The local motion detector determines whether local motion occurs by comparing the determined features of the windows of the current image with features of corresponding windows of a previous image.

### BRIEF DESCRIPTION OF THE DRAWINGS

FIG. 1 shows a block diagram illustrating an imaging system with motion detection according to one embodiment of the present invention;

FIG. 2A shows a flow diagram illustrating an imaging method with motion detection according to one embodiment of the present invention;

FIG. 2B shows a flow diagram illustrating an imaging method with motion detection according to another embodiment of the present invention;

FIG. 3A to FIG. 3E show exemplary windows layouts;

FIG. 4 shows an example of determining features of the windows;

FIG. 5A shows a detailed block diagram illustrating the local motion detector of FIG. 1; and

FIG. 5B shows a detailed block diagram illustrating the global motion detector of FIG. 1.

### DETAILED DESCRIPTION OF THE INVENTION

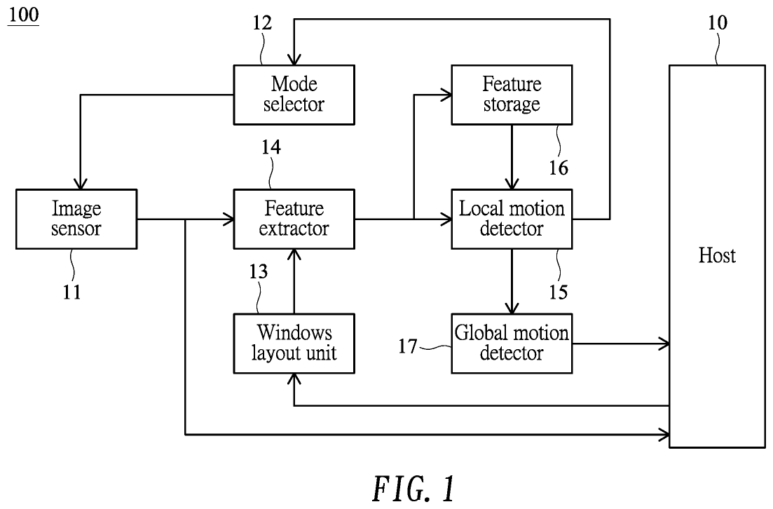

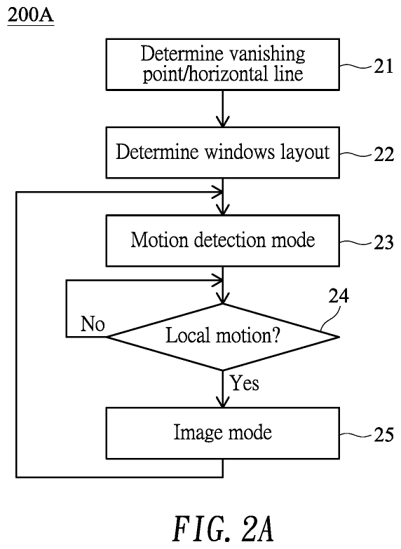

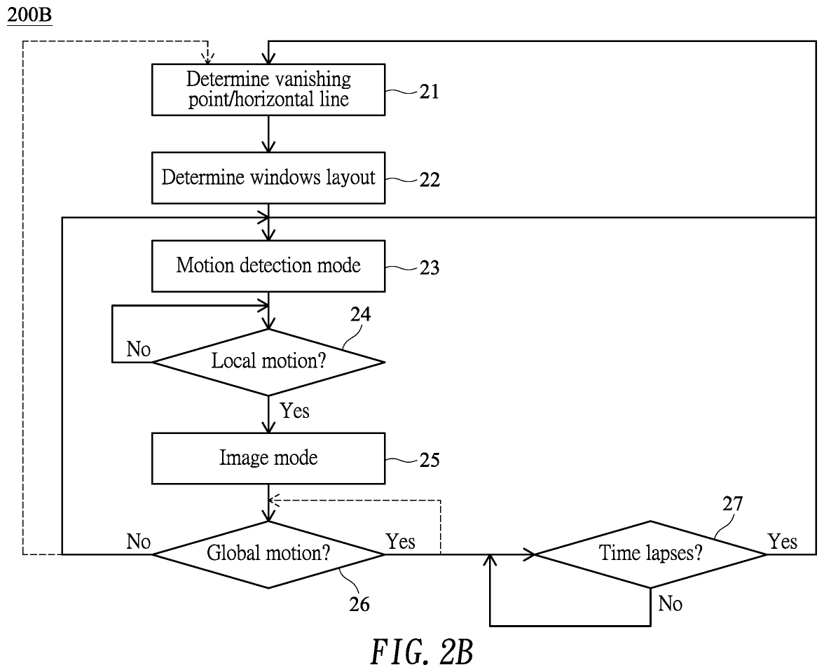

FIG. 1 shows a block diagram illustrating an imaging system 100 with motion detection according to one embodiment of the present invention. The blocks of the imaging system 100 may be implemented or performed by hardware (e.g., an image signal processor) and/or software (e.g., a computer program). FIG. 2A shows a flow diagram illustrating an imaging method 200A with motion detection according to one embodiment of the present invention.

In the embodiment, the imaging system 100/imaging method 200A may be an event-triggered imaging system/method for substantially reducing power consumption and bandwidth. The imaging system 100 of the embodiment may include an image sensor 11 such as a complementary metal-oxide-semiconductor (CMOS) image sensor. The imaging system 100 of the embodiment may include a mode selector 12 configured to determine a current mode, according to which the image sensor 11 may have different resolutions, amounts of power consumption or frame rates. In the embodiment, the imaging system 100 may have, at least, a motion detection mode and an image (or image/video) mode.

Specifically, in step 21, an image is captured (by the image sensor 11), and a vanishing point or a horizontal line on the captured image is then determined. The vanishing point is a point on an image plane where the two-dimensional perspective projections of mutually parallel lines in three-dimensional space appear to converge, and the horizontal line (commonly called eye level) is a line on which the vanishing point is located. In one embodiment, the captured image is transferred to a host 10, which acts as an image analyzer capable of identifying the vanishing point or the horizontal line of the captured image. The host 10 may, for example, be disposed at a remote site. In another embodiment, the vanishing point/horizontal line may be set by a user. In a further embodiment, the vanishing point/horizontal line may be predetermined, and thus step 21 and the image analyzer may be omitted.

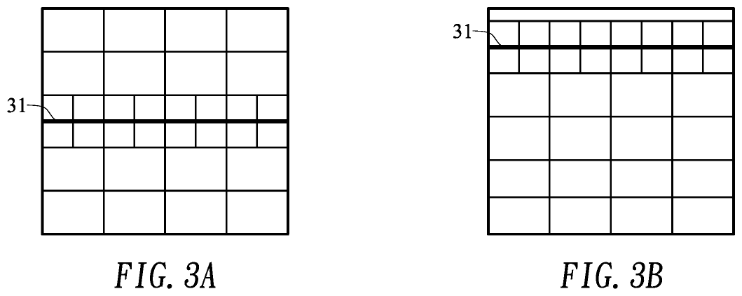

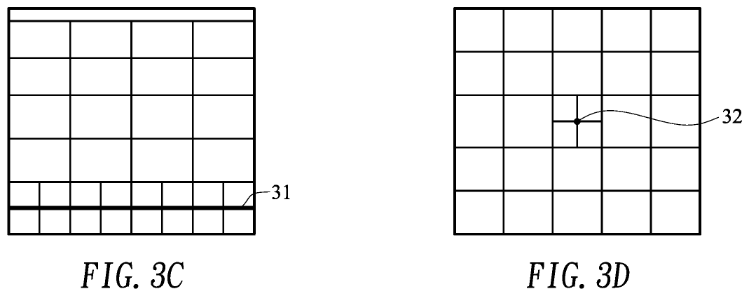

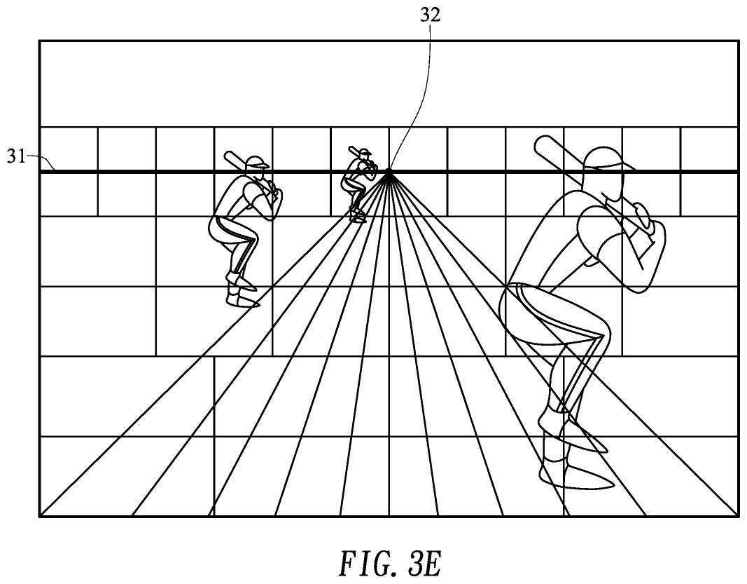

Next, in step 22, a windows layout for motion detection is determined, by a windows layout unit 13, according to the horizontal line or the vanishing point. According to one aspect of the embodiment, sizes of windows in the determined windows layout are not uniform. Specifically, in the embodiment, windows near the horizontal line/vanishing point are smaller than windows far away from the horizontal line/vanishing point. FIG. 3A to FIG. 3D show exemplary windows layouts. It is observed that windows near the horizontal line 31 or the vanishing point 32 are smaller than windows far away from the horizontal line 31 or the vanishing point 32. It is noted that sometimes (e.g., in FIG. 3B and FIG. 3C) no window is assigned to a portion (e.g., sky) or portions of the captured image.

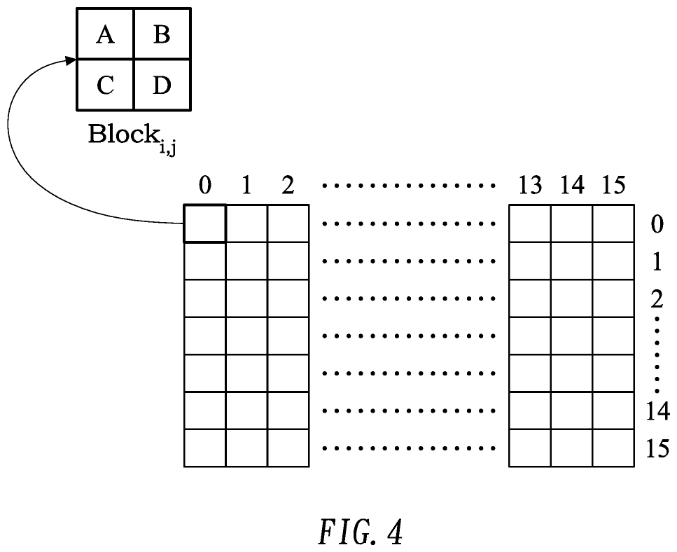

After determining the windows layout, the mode selector 12 switches the imaging system 100 to the motion detection mode (step 23). The imaging system 100 of the embodiment may include a feature extractor 14, a local motion detector 15 and a feature storage 16. Specifically, the feature extractor 14 determines features of the windows of a current image (captured by the image sensor 11). The determined features of windows may be stored in the feature storage 16 such as static random-access memory (SRAM) or dynamic random-access memory (DRAM). In one example, the feature of a window is an average value of pixels within the associated window. FIG. 4 shows another example of determining features of the windows. Specifically, each block (or window) is divided into a plurality of sub-blocks (e.g., 2×2 sub-blocks designated as A, B, C and D as exemplified in FIG. 4). The sub-blocks A-D are subjected to the following computation to determine the feature of the corresponding block:

Block feature_{i,j}=(abs[mean(A+B)−mean(C+D)]+abs[mean(B+D)−mean(A+C)])/2

In step 24, the determined features of windows of the current image are then compared with features of corresponding windows of a previous image stored in the feature storage 16, by the local motion detector 15, in order to determine whether (local) motion occurs. Step 24 repeatedly performs until motion is detected.

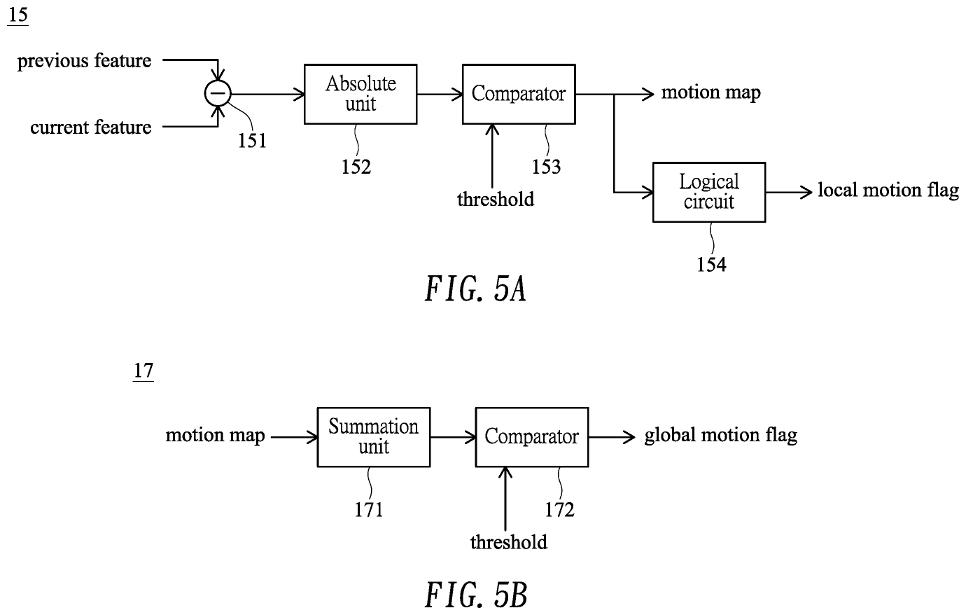

FIG. 5A shows a detailed block diagram illustrating the local motion detector 15 of FIG. 1. In the embodiment, the local motion detector 15 may include a difference unit 151 that subtracts a current feature from a previous feature, thereby resulting in a difference value. The local motion detector 15 may include an absolute unit 152 that generates an absolute value of the difference value. The local motion detector 15 may also include a comparator 153 that compares the absolute value with a predetermined threshold. According to the results of the comparator 153, a motion map may then be generated. The local motion detector 15 may further include a logical circuit 154, such as OR gate, that performs logical operation on the results of the comparator 153 (i.e., the motion map), thereby generating a local motion flag indicating whether (local) motion occurs.

When local motion is detected, the flow goes to step 25, in which the mode selector 12 switches the imaging system 100 to the image (or image/video) mode, in which image or video is captured and transferred (that is, streamed) to the host 10. After the image or video is transferred, the flow goes back to step 23, in which the mode selector 12 switches the imaging system 100 to the motion detection mode.

FIG. 2B shows a flow diagram illustrating an imaging method 200B with motion detection according to another embodiment of the present invention. Steps 21-24 of the present embodiment (FIG. 2B) are the same as those in FIG. 2A. In step 25 (i.e., image mode), the image or video is captured and streamed to the host 10, and the flow then goes to step 26 to determine, by the global motion detector 17, whether global motion occurs. If global motion is detected, indicating that the video (or images) is presently unsteady, the imaging system 100 should wait (in step 27) for a predetermined period of time; otherwise the flow goes back to step 23 (i.e., motion detection mode). Step 27 repeatedly performs until the predetermined period of time lapses, and the flow goes to step 21 to determine a new vanishing point or a horizontal line. Next, in step 22, a new windows layout for motion detection is determined, by a windows layout unit 13, according to the new horizontal line or the vanishing point. In an alternative embodiment as designated by dashed lines in FIG. 2B, if global motion is detected in step 26, step 26 repeatedly performs until no global motion is detected. At that time, the flow goes to step 21 to determine a new vanishing point or a horizontal line. Next, in step 22, a new windows layout for motion detection is determined, by a windows layout unit 13, according to the new horizontal line or the vanishing point.

FIG. 5B shows a detailed block diagram illustrating the global motion detector 17 of FIG. 1. In the embodiment, the global motion detector 17 may include a summation unit 171 that adds up elements of the motion map (from the local motion detector 15), thereby resulting in a sum value. The global motion detector 17 may include a comparator 172 that compares the sum value with a predetermined threshold, thereby generating a global motion flag indicating whether global motion occurs. Specifically, the global motion flag is asserted, indicating the global motion occurs, when the sum value is greater than the predetermined threshold, otherwise the global motion flag is de-asserted. In another embodiment, the global motion may be detected by monitoring the horizontal line (or the vanishing point). Global motion is detected when the horizontal line (or the vanishing point) shifts with a substantive distance.

According to the embodiment set forth above, as sizes of windows for motion detection are not uniform, distant moving objects with small image size will not be missed. FIG. 3E shows an exemplary windows layout according to the embodiment of the present invention. It is observed that a distant person has a smaller image size than a near person even they have the substantially same actual size. As the distant person is confined in small windows, when the distant person moves (e.g., from a window to a neighbor window), the local motion detector 15 can detect the local motion of the distant person by comparing features captured at different times. On the other hand, as the near person is confined in large windows, computation task and the feature storage size may be substantially reduced. It is noted that the horizontal line is preferably used for an image, on which an object (e.g., a person in FIG. 3E) capable of moving not only forward and backward but also leftward and rightward. An object far away from the horizontal line on such image is regarded as a near object. On the contrary, the vanishing point is preferably used for an image, on which an object capable of moving only forward and backward (e.g., a car through a tunnel). An object far away from the vanishing point on such image is regarded as a near object.

Although specific embodiments have been illustrated and described, it will be appreciated by those skilled in the art that various modifications may be made without departing from the scope of the present invention, which is intended to be limited solely by the appended claims.

What is claimed is:

1. An imaging system with motion detection, comprising:
an image sensor;
a windows layout unit that determines a windows layout according to a vanishing point or a horizontal line, sizes of windows in the determined windows layout being not uniform;
a feature extractor that determines features of the windows of a current image; and
a local motion detector that determines whether local motion occurs by comparing the determined features of the windows of the current image with features of corresponding windows of a previous image.

2. The system of claim 1, further comprising an image analyzer that identifies the vanishing point or the horizontal line.

3. The system of claim 1, wherein windows near the vanishing point or the horizontal line are smaller in size than windows far away from the vanishing point or the horizontal line.

4. The system of claim 1, wherein the feature extractor determines the feature of a window as an average value of pixels within the associated window.

5. The system of claim 1, wherein the local motion detector comprises:
a difference unit that subtracts a feature of the current image from a feature of the previous image, thereby resulting in a difference value;
an absolute unit that generates an absolute value of the difference value;
a comparator that compares the absolute value with a predetermined threshold, thereby generating a comparison result; and
a logical circuit that generates a local motion flag indicating whether the local motion occurs according to comparison results associated with the features of the windows of the current image and the previous image.

6. The system of claim 1, further comprising:
a global motion detector that determines whether global motion occurs.

7. The system of claim 6, wherein the global motion detector comprises:
a summation unit that adds up the features of the windows of the current image, thereby resulting in a sum value; and
a comparator that compares the sum value with a predetermined threshold, thereby generating a comparison result, according to which a global motion flag is generated.

8. The system of claim 1, further comprising:
a mode selector that sets a motion detector mode after determining the window layout, and sets an image mode when the local motion is detected.

9. The system of claim 1, further comprising:
a feature storage that stores the features of the windows.

10. The system of claim 1, wherein the imaging system is an event-triggered imaging system.

11. An imaging method with motion detection, comprising:
determining a windows layout according to a vanishing point or a horizontal line, sizes of windows in the determined windows layout being not uniform;
determining features of the windows of a current image;
comparing the determined features of the windows of the current image with features of corresponding windows of a previous image to determine whether local motion occurs.

12. The method of claim 11, further comprising a step of identifying the vanishing point or the horizontal line.

13. The method of claim 11, wherein windows near the vanishing point or the horizontal line are smaller in size than windows far away from the vanishing point or the horizontal line.

14. The method of claim 11, wherein the feature of a window is an average value of pixels within the associated window.

15. The method of claim 11, wherein the local motion is determined by the following steps:
subtracting a feature of the current image from a feature of the previous image, thereby resulting in a difference value;
generating an absolute value of the difference value;
comparing the absolute value with a predetermined threshold, thereby generating a comparison result; and
generating a local motion flag indicating whether the local motion occurs according to comparison results associated with the features of the windows of the current image and the previous image.

16. The method of claim 11, further comprising:
determining whether global motion occurs.

17. The method of claim 16, wherein the global motion is determined by the following steps:
adding up the features of the windows of the current image, thereby resulting in a sum value; and
comparing the sum value with a predetermined threshold, thereby generating a comparison result, according to which a global motion flag is generated.

18. The method of claim 11, wherein a motion detector mode is set after determining the window layout, and an image mode is set when the local motion is detected.

19. The method of claim 11, further comprising:
storing the features of the windows.

20. The method of claim 1, wherein the imaging method is an event-triggered imaging method.
